(19) United States
(12) Patent Application Publication
(10) Pub. No.: US 2005/0021739 A1
(43) Pub. Date: Jan. 27, 2005

(54) Methods, systems and computer program products for communicating the expected efficacy of invoking a network turbo boost service

(76) Inventors: Sharon E. Carter, Austell, GA (US); Nicholas S. Huslak, Duluth, GA (US); A. C. McQuaide JR., Berkeley Lake, GA (US)

Correspondence Address: CANTOR COLBURN LLP, 55 GRIFFIN ROAD SOUTH, BLOOMFIELD, CT, 06002, US

(21) Appl. No.: 10/737,558

(22) Filed: Dec. 16, 2003

Related U.S. Application Data
(60) Provisional application No. 60/470,650, filed on May 15, 2003.

(51) Int. Cl. G06F 15/173

(52) U.S. Cl. 709/224; 718/104

(57) ABSTRACT

A method for communicating the expected efficacy of invoking a network turbo boost service including receiving notification of a task to be executed, where the task includes access to a network. A request to predict an expected impact of applying the network turbo boost service to the task is received. The expected impact, responsive to a current computing environment is predicted. The expected impact is communicated to a user.

### RELATED APPLICATION

This application claims the benefit of and priority to U.S. Provisional Patent Application No. 60/470,650, filed May 15, 2003, the disclosure of which is hereby incorporated herein by reference as if set forth in its entirety.

### FIELD OF THE INVENTION

The present disclosure relates generally to a method of communicating the expected efficacy of invoking a network turbo boost service and in particular, to a method of predicting the expected efficacy of invoking a network turbo boost service and communicating the expected efficacy to a potential user of the network turbo boost service.

### BACKGROUND OF THE INVENTION

Increasing amounts and types of information are becoming available via networks such as the Internet and various types of networks that allow access to the Internet, such as DSL networks and cable television networks. Consumers are downloading files to their personal computers and/or to their personal networks that contain information such as voice data, graphics data, audio-visual multimedia data (e.g., television programs, movies, audio) and other types of data. As the files consumers are downloading have become larger and larger in size, several corporations have introduced products aimed at reducing the amount of time it takes to download large files. Examples of such products include WebRocket and ActiveSpeed Internet Accelerator from Ascentive. These products are aimed at increasing the efficiency of the download process by optimizing the download from the user side of the process (e.g., personal computer and/or personal network). In addition, there are other manners of expediting the download process, such as utilizing a multi-link environment that is supported by some Internet Service Providers (ISPs). The multi-link environment includes a user system (e.g., personal computer) that contains two modems and two telephone lines connected to the modems, which in turn are in communication with the ISP. In this manner, data may be downloaded at about twice the speed of a single modem.

ISPs are beginning to offer broadband “turbo boost” services that offer temporary access to improved data transmission speed for a limited time in exchange for a per-use or standing fee. The improved transmission vehicle is typically an increase in upstream and downstream throughput that benefits any throughput-intensive activity that the user may be engaged in such as downloading files or streaming video/audio content. Once a user subscribes to the service, the service may be invoked manually by the user or invoked automatically based on local environmental conditions or conditions in the broader network that the user can define in advance. Although a network turbo boost service invocation could result in a huge improvement in performance (due to increased bandwidth) at certain times, there may be little or no improvement at other times because of conditions in various segments of the network and/or due to customer provided equipment (CPE) limitations/conditions. Accordingly, the user may have difficulty deciding on whether to invoke the network turbo boost service at any given time because there is uncertainty regarding the degree of throughput improvement that will result. This could be perceived as inconsistent network turbo service performance and may result in the service provider having difficulty in managing the user's expectations of the network turbo boost service and in customer dissatisfaction with the network turbo boost service.

### BRIEF DESCRIPTION OF THE DRAWINGS

FIG. 1 is a block diagram of an exemplary system for communicating the expected efficacy of invoking a network turbo boost service.

FIG. 2 depicts an exemplary process for communicating the expected efficacy of invoking a network turbo boost service.

### SUMMARY OF THE INVENTION

Embodiments of the invention include a method for communicating the expected efficacy of invoking a network turbo boost service. The method includes receiving notification of a task to be executed, where the task includes access to a network. A request to predict an expected impact of applying the network turbo boost service to the task is received. The expected impact, responsive to a current computing environment is predicted. The expected impact is communicated to a user.

Additional embodiments include a system for communicating the expected efficacy of invoking a network turbo boost service. The system includes a network and a service provider system in communication with the network. The service provider system includes instructions to implement a method including receiving notification of a task to be executed, where the task includes access to the network. A request to predict an expected impact of applying the network turbo boost service to the task is received via the network. The expected impact, responsive to a current computing environment is predicted. The expected impact is communicated to a user via the network.

Further embodiments include a computer program product for communicating the expected efficacy of invoking a network turbo boost service. The computer program product includes a storage medium readable by a processing circuit and storing instructions for execution by the processing circuit for performing a method including receiving notification of a task to be executed, where the task includes access to a network. A request to predict an expected impact of applying the network turbo boost service to the task is received. The expected impact, responsive to a current computing environment is predicted. The expected impact is communicated to a user.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DETAILED DESCRIPTION OF THE INVENTION

Exemplary embodiments of the present invention provide a computer user with information about an expected performance improvement associated with utilizing a network turbo boost service in a current computing environment. This information is derived from conditions in various segments of the broadband network at the time that the prediction is requested from the user. These conditions may have an effect on how much of an impact increasing the bandwidth will have on shortening a file download time or otherwise improving the sending and receiving of data from the user's computer. By utilizing exemplary embodiments of the present invention, the user receives insight into the advantages of invoking the network turbo boost service “now.” This may allow the network turbo boost service provider to more effectively manage the expectations of potential users of the network turbo boost service and may lead to fewer trouble calls with complaints that the service “didn't work.”

Upon receipt of a network turbo boost service estimator request for a task, exemplary embodiments of the present invention utilize current computing environment status information to predict how long the task (e.g., file download, file upload, streaming video, streaming audio, gaming application) will take to complete with vs. without the network turbo boost service. The user is provided with this information, via a user interface or application interface, and may then decide whether to invoke the network turbo boost service. Exemplary embodiments of the present invention may be utilized in combination with any broadband access network (e.g., cable, wireline DSL, wireless DSL, satellite).

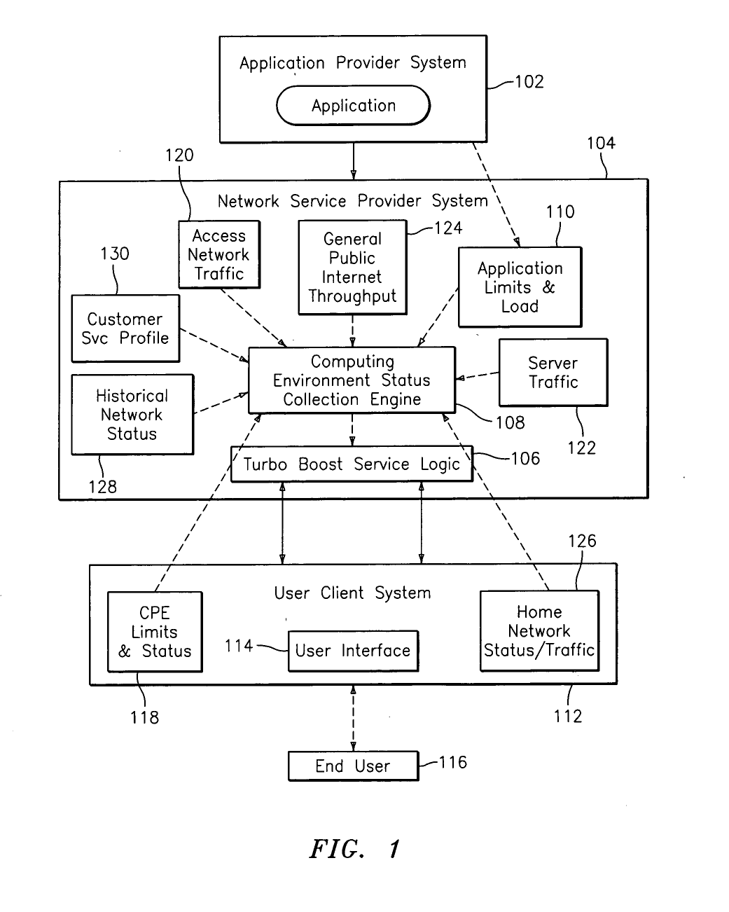

FIG. 1 is a block diagram of an exemplary system for communicating the expected efficacy of invoking a network turbo boost service to an end user 116, customer provided equipment (CPE) limits and status information 118, and home network status/traffic data 126. The system includes an end user 116 accessing a user client system 112. The solid lines in FIG. 1 denote network data flows while the dotted lines denote an interaction among the invention components as utilized by exemplary embodiments of the present invention. In exemplary embodiments of the present invention, the user client system 112 is a personal computer that is in communication with the network service provider system 104 via a network. The user client system 112 includes a user interface 114 that is presented to the end user 116. The user interface 114 allows the end user 116 to request an estimate of an expected network turbo boost service benefit for a particular task. The user interface 114 also allows the end user 116 to be presented with the expected decrease in task execution time and to be presented with the option of selecting the network turbo boost service in association with the execution of the task. The user interface 114 may display information to the end user 116 in a text and/or graphic format.

The system depicted in FIG. 1 also includes a network service provider system 104 that includes access network traffic data 120, server traffic data 122, general public Internet throughput data 124, historical network traffic data 128, customer service profile data 130, application limits and load information 110, a computing environment status collection engine 108, and turbo boost service logic 106. The turbo boost service logic 106 receives the network turbo boost service estimate request for a task from the user client system 112 or from the application provider system 102. In addition, the turbo boost service logic 106 receives current computing environment status information (e.g., application conditions, network conditions, historical network status) from the computing environment status collection engine 108 and calculates a prediction of the expected savings that will result from invoking the network turbo boost service for the task.

Inputs to the computing environment status collection engine 108, as depicted in FIG. 1 may include one or more of the following: server traffic data 122; home network status/traffic data 126; customer service profile data 130; general public Internet throughput data 124; customer provided equipment (CPE) limits and status information 118; application limits and load information 110; access network traffic data 120 and historical network status data 128. Access network traffic data 120 is utilized to determine if the incremental bandwidth utilized by the network turbo boost is readily available. The computing environment status collection engine 108 may query the access network to determine if current traffic may impact whether the bandwidth is readily available. The bandwidth may not be as readily available during busy hours as it is during off-peak hours. Server traffic data 122 refers to traffic data on the site where the file or website to be downloaded or accessed is located. This data includes information about the number of users currently accessing the server traffic site. The number of users currently accessing the server traffic site may limit the share of the server's ability to send data. Home network status/traffic data 126 is collected to determine, for example, if there are other bandwidth-thirsty processes running on the other networked machines or if someone else on the network is already downloading large (e.g., MP3) files. If these conditions are detected this may indicate that any benefit the user receives from the network turbo boost service invocation would have to be shared with the other processes.

General public Internet throughput data 124 may also be collected to determine if the current Internet throughput will impact or offset the potential benefits of increased bandwidth. CPE limits and status information 118 are collected to determine if the CPE has the capacity to benefit from an increased bandwidth. For example, the CPE may not have a CPU that is fast enough to handle receiving data at the faster speed made possible by an increased bandwidth or the CPE may not have allocated enough memory to buffer space to handle a data rate made possible by an increased bandwidth. Historical network status data 128 includes an adaptive/frequently updated database of network statistics. Network statistics may include information such as global busy hours vs. low usage hours for the Internet in general as well as for individual sites. The historical network status data 128 is utilized by the computing environment status collection engine 108 as another data source to predict the expected impact of invoking the network turbo boost service. The customer service profile data 130 provides information about the customer such as the maximum DSL sync rate allowed for the customer. For example, if the maximum DSL sync rate for a customer is only 1.5 meg per second, then the provider may decide not to inform the customer about the network turbo boost service (and/or may not allow the customer to invoke network turbo boost service). Alternatively, the provider may allow the customer to invoke the network turbo boost service with an appropriate warning.

The data types depicted in FIG. 1 are examples of the type of data that may be collected to predict the impact (e.g., on speed) of increased bandwidth (or other transmission improvements) on a task (e.g., a file download). Any type of data having an impact on predicting the expected efficacy of the network turbo boost service may be collected by the computing environment status collection engine 108 for input to the turbo boost service logic 106. The turbo boost service logic 106 receives all of this information, calculates an improvement estimate and provides the turbo boost improvement estimate to the user.

The expected impact, or time-savings, is communicated to the user. For example, the CPE may include a central processing unit (CPU) with a speed that can only handle half of the increase in incremental data throughput that will be transmitted due to an increased bandwidth. In this case, the turbo boost service logic 106 may calculate that doubling the bandwidth would only result in a twenty-five percent decrease in download time (vs. a fifty percent decrease if all of the increased bandwidth could be utilized). In exemplary embodiments of the present invention, the turbo boost service logic 106 communicates the original download time estimate and the revised network turbo boost service download time estimate. In another example, the router at the server containing the file to be downloaded may only be able to send data to the user at the current bandwidth rate. In this case, increasing the bandwidth would not make a difference in the speed of the download. The turbo boost service logic 106 communicates this to the user via the user interface 114. Any other methods known in the art may be utilized to collect and analyze network data, application data, CPE data, and historical network status data for predicting the effect of increasing a bandwidth on a file download speed. In an alternate exemplary embodiment of the present invention, the reason for any restriction (e.g., CPE, application limit) is also communicated to the user.

In addition, FIG. 1 includes an application provider system 102 resident on or in communication with the network service provider system 104. The application provider system 104 can request a prediction of an expected impact of invoking the network turbo boost service for a particular task. In response to the estimated amount of savings and possibly based on certain conditions (e.g., the savings is above a pre-selected threshold), an application located on, or in communication with, the application provider system 102 may request that the network turbo boost service be invoked or that it be offered to the end user 116 of the application. In addition, the application provider system 102 provides application data (e.g., limits, load) to the network provider system 104 for use in predicting the expected efficacy, or impact, of invoking the network turbo boost service.

In exemplary embodiments of the present invention, the network turbo boost service is applied to any throughput-intensive tasks or activities including downloading web pages, visiting graphic intensive web sites, uploading large files, downloading large files, playing streaming video or audio files, or participating in interactive gaming.

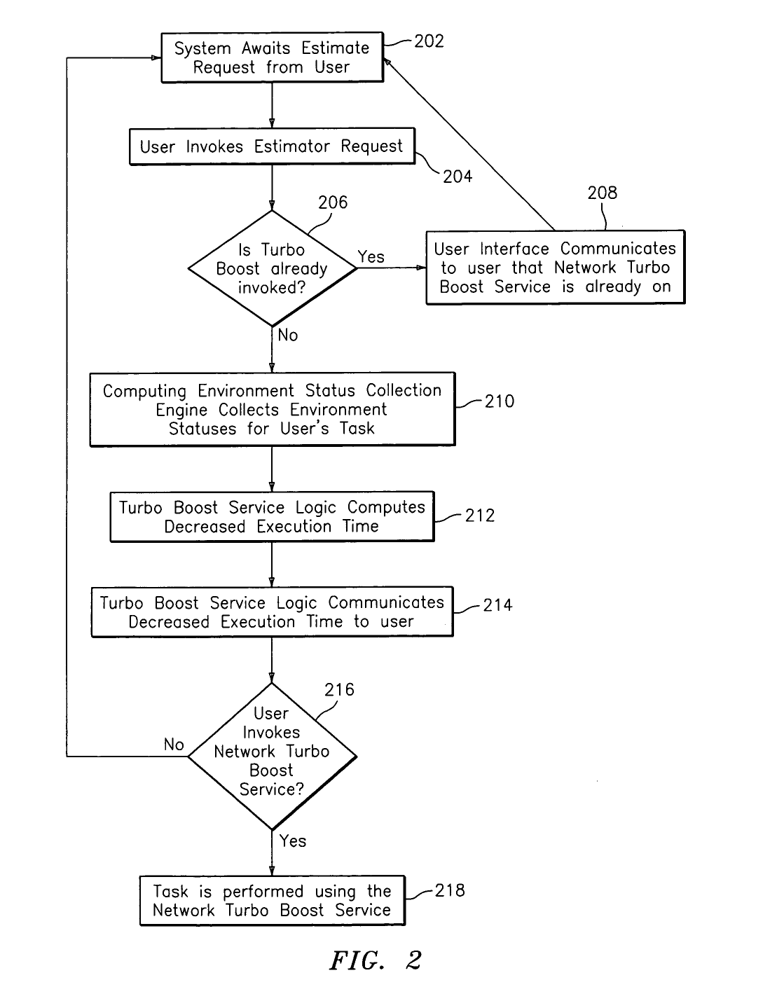

FIG. 2 depicts an exemplary process for communicating the expected efficacy of invoking a network turbo boost service. A user invocation of the estimator function for task is awaited by the system at 202. At 204, a request for a turbo boost estimate to be computed for a task is received. In response to the request, the system, at 206, checks to determine if the turbo boost service is already invoked. It the turbo boost is already invoked, then 208 is performed. At 208, the user interface communicates to the user that the network turbo boos service is already on. Processing then continues at 202. If the turbo boost service is not already invoked, as determined at 206, then the computing environment status collection engine 108 collects environment statuses for the user's task at 210 and communicates it to the turbo boost service logic 106. Next, at 212, the turbo boost service logic 106 computes/predicts the expected decrease in execution time for the task using input data that includes information from the computing environment status collection engine 108.

At 214 in FIG. 2, the turbo boost service logic 106 communicates the expected improvement (if any) to the user, via the user interface 114 (or via an application interface if the request is from an application program). The user is notified of the opportunity to potentially decrease processing time (e.g., “press your turbo button to potentially decrease your download time from ten minutes to two minutes”). Next, at 216, a check is made to determine if the user has selected the network turbo boost service to be invoked for the task. If, it is determined at 216 that the user has selected the turbo boost button, then, at 218, the network service provider system 104 provides the increased throughput (or other transmission improvement) and the task (e.g., a high-throughput task) is initiated using the network turbo boost service. Processing then continues at 202. If, at 216 it is determined that the user has not selected the turbo boost service, then processing continues at 202.

Given the current technology, the turbo boost efficacy calculation does not result in an exact quantification of data transmission speed, and those skilled in the art may have varied opinions regarding how much weight should be assigned to each of the computational components. Exemplary embodiments of the present invention allow the flexibility that the implementers and/or network providers and/or users may choose to only include certain calculation components and they may apply different weights to different components to calculate expected efficacy. In exemplary embodiments of the present invention, the CPE limitations and status data 118 are sampled before figuring in other components to the expected efficacy calculation because local bottlenecks may preclude the user from ever benefiting from the network turbo boost service. In such cases, the efficacy calculation is computed and communicated to the user without exercising the resources that would be necessary to sample the other components. Similarly, exemplary embodiments of the present invention include having the computation first sample the components that the network service provider has ready access to and that are common to any users requesting estimates at that time (e.g., access network traffic data 120). Polling the user-specific details that are sampled in real time (e.g., server traffic data 122) is held off until it is determined that the component is actually needed to complete the calculation. In some cases, the system may determine that traffic is sufficiently congested that the server traffic conditions are moot and the system may communicate an estimate o the user without having ever sampled (or factored in) the server traffic data 122.

By utilizing exemplary embodiments of the present invention, the user receives insight into the advantages of invoking the network turbo boost service “now.” This may allow the service provider to more effectively manage the expectations of the users of the network turbo boost and may lead to fewer trouble calls with complaints that the service “didn't work.”

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for communicating the expected efficacy of invoking a network turbo boost service comprising:
receiving a notification of a task to be executed, the task including access to a network;
receiving a request to predict an expected impact of applying the network turbo boost service to the task;
predicting the expected impact responsive to a current computing environment; and
communicating the expected impact to a user.

2. The method of claim 1 further comprising:
receiving a request to invoke the network turbo boost service for the task; and
invoking the network turbo boost service for the task in response to the request to invoke the network turbo boost service for the task.

3. The method of claim 1 wherein the network turbo boost service includes an increase in bandwidth on the network.

4. The method of claim 1 wherein the task includes accessing a website.

5. The method of claim 1 wherein the task includes downloading data.

6. The method of claim 1 wherein the task includes uploading data.

7. The method of claim 1 wherein the task includes streaming audio data.

8. The method of claim 1 wherein the task includes streaming video data.

9. The method of claim 1 wherein the task includes an interactive gaming activity.

10. The method of claim 1 further comprising determining the current computing environment including collecting environment status data.

11. The method of claim 10 wherein the environment status data includes one or more of access network traffic data, customer provided equipment limits and status information, and application limits and load information.

12. The method of claim 10 wherein the environment status data includes one or more of server traffic data, home network status/traffic data, general public Internet throughput data, customer provided equipment limits and status information, customer service profile data and access network traffic data.

13. The method of claim 10 wherein the environment status data includes historical network status data.

14. The method of claim 10 wherein the environment status data are collected on a pre-selected basis.

15. The method of claim 10 wherein the environment status data are collected in response to the receiving a request to predict an expected impact of applying the network turbo boost service to the task.

16. The method of claim 1 wherein the communicating is via a text display.

17. The method of claim 1 wherein the communicating is via a graphical display.

18. The method of claim 1 wherein the communicating includes displaying bottlenecks associated with the expected impact.

19. The method of claim 1 wherein the expected impact includes a first predicted elapsed time if the network turbo boost service is not invoked and a second predicted elapsed time if the network turbo boost service is invoked.

20. The method of claim 1 wherein the user is an end-user.

21. The method of claim 1 wherein the user is an application program.

22. The method of claim 1 wherein the user is an application program and the method further comprises communicating an option to a user client system to invoke the network turbo boost service for the task if the expected impact meets a pre-selected threshold.

23. A system for communicating the expected efficacy of invoking a network turbo boost service comprising:
a network; and
a service provider system in communication with the network, wherein the service provider system includes instructions to implement a method comprising:
receiving notification of a task to be executed, the task including access to the network;
receiving a request via the network to predict an expected impact of applying the network turbo boost service to the task;
predicting the expected impact responsive to a current computing environment; and
communicating via the network the expected impact to a user.

24. The system of claim 23 wherein the network is the Internet.

25. The system of claim 23 wherein the network is a broadband network.

26. A computer program product for communicating the expected efficacy of invoking a network turbo boost service comprising:
a storage medium readable by a processing circuit and storing instructions for execution by the processing circuit for performing a method comprising:
receiving a notification of a task to be executed, the task including access to a network;
receiving a request to predict an expected impact of applying the network turbo boost service to the task;
predicting the expected impact responsive to a current computing environment; and
communicating the expected impact to a user.
